(19) United States
(12) Patent Application Publication
(10) Pub. No.: US 2024/0211527 A1
(43) Pub. Date: Jun. 27, 2024

(54) MONITORING AND CONTROLLING THE ACTIONS OF A BROWSER

(71) Applicant: Salesforce, Inc., San Francisco, CA (US)

(72) Inventors: Jordan Dapper, Alexandria, KY (US); Jason Torres, Bradenton, FL (US); Bo Ma, Vancouver (CA)

(73) Assignee: Salesforce, Inc., San Francisco, CA (US)

(21) Appl. No.: 18/146,813

(22) Filed: Dec. 27, 2022

(51) Int. Cl. G06F 16/957; G06F 3/0485; G06F 9/54

(52) U.S. Cl. CPC G06F 16/9577; G06F 3/0485; G06F 9/54

(57) ABSTRACT

A method and system for monitoring the status of a requested network action for a browser has been developed. The method first receives a network request for an action to execute a script with the browser. Network activities of the browser are then monitored to ensure no network activities are present that change a document object model (DOM) data. The browser is monitored to ensure no mutation of the DOM data is taking place. The script is monitored to ensure that it is not blocked in a viewport of the browser. The script is executed when it is determined that, no network activities of the browser are present, no mutation of the DOM data is taking place in the browser, and the script is not blocked in the viewport of the browser.

### TECHNICAL FIELD

Embodiments of the subject matter described herein relate generally to operation of web based applications. More particularly, embodiments of the subject matter relate to monitoring and controlling the actions of a browser.

### BACKGROUND

Typical interactions with network or “web” browser driver perform actions like click and send text to a specific element. The browser and the element need to be in a stable state to receive actions. Otherwise, an element may lose its original target and cause an error exception. This typically results false failures for user's execution of a scripted program. Accordingly, there is a need in the art for a method and system for monitoring and controlling the actions of a browser.

### BRIEF DESCRIPTION OF DRAWINGS

A more complete understanding of the subject matter may be derived by referring to the detailed description and claims when considered in conjunction with the following figures, wherein like reference numbers refer to similar elements throughout the figures.

FIG. 1A is a diagram of a document object model (DOM) data tree in accordance with one embodiment;

FIG. 1B is a display of a browser viewport in accordance with one embodiment;

FIG. 1C is a diagram of a mutation observer for a DOM data tree in accordance with one embodiment;

FIG. 2 shows a flowchart depicting a method for monitoring and controlling the actions of a web browser in accordance with one embodiment; and

FIG. 3 is a schematic block diagram of an exemplary multi-tenant computing environment in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description. Example embodiments will now be described more fully with reference to the accompanying drawings.

A method and system for monitoring the status of a requested network action for a browser has been developed. The method first receives a network request for an action to execute a script with the browser. Network activities of the browser are then monitored to ensure no network activities are present that change a document object model (DOM) data. The browser is monitored to ensure no mutation of the DOM data is taking place. The script is monitored to ensure that it is not blocked in a viewport of the browser. The script is executed when it is determined that, no network activities of the browser are present, the script is not blocked in the viewport of the browser, and no mutation of the DOM data is taking place in the browser.

A “web page” is a Hyper Text Markup Language (HTML) document stored on a web server. The web page is delivered to a user by the server and displayed in a web browser. A “website” comprises many web pages linked together under a common domain name. The core element of a web page is a text file written in HTML that describes the content of the web page and includes references to other web resources. The web page is a structured document that primarily consists of hypertext, text with hyperlinks. “Hyperlinks” point the user to other web resources, primarily other web pages, and to different sections of the same web page. Multimedia content on the web, such as images, videos, and other web pages, can be directly embedded in a web page to form a compound document.

For web page usage, there are two types of web pages: static and dynamic. Static pages are retrieved from the web server's file system without any modification, while dynamic pages must be created by the server, typically reading from a database to fill out a template, before being sent to the user's browser. An HTML document can include Cascading Style Sheets (CSS) documents to describe the presentation of content on a web page. It can also include JavaScript or WebAssembly programs, which are executed by the browser to add dynamic behavior to the web page. Web pages with dynamic behavior can function as application software, referred to as web applications.

Each web page is identified by a distinct Uniform Resource Locator (URL). When the user inputs the URL for a web page into their browser, the browser downloads an HTML file from a web server and transforms all of its elements into an interactive visual representation on the user's device. If the user clicks, taps, or otherwise activates a hyperlink, the browser repeats this process to load the page pointed to by the hyperlink, which could be part of the current website or a different one. The browser has user interface features that indicate which page is displayed.

A “script” is an HTML element is used to embed executable code or data in an HTML webpage to make them dynamic and interactive. For example, with scripts, you can create a pop-up box message, a dropdown menu, etc. JavaScript is the most common scripting language used on websites. A “Document Object Model” (DOM) connects webpages to scripts by representing the structure of a document in memory. Usually, a DOM uses JavaScript, even though modeling HTML, SVG, or XML documents as objects are not part of the core JavaScript language.

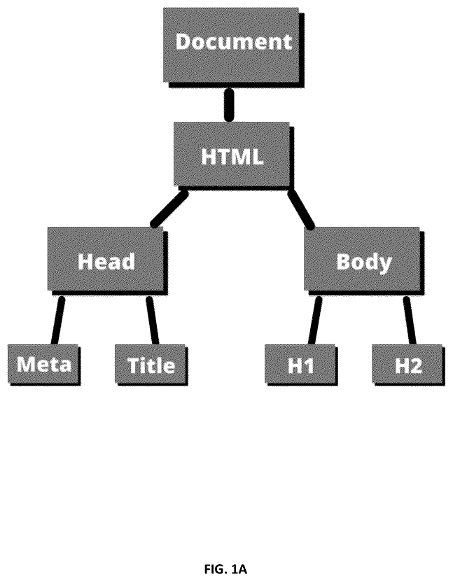

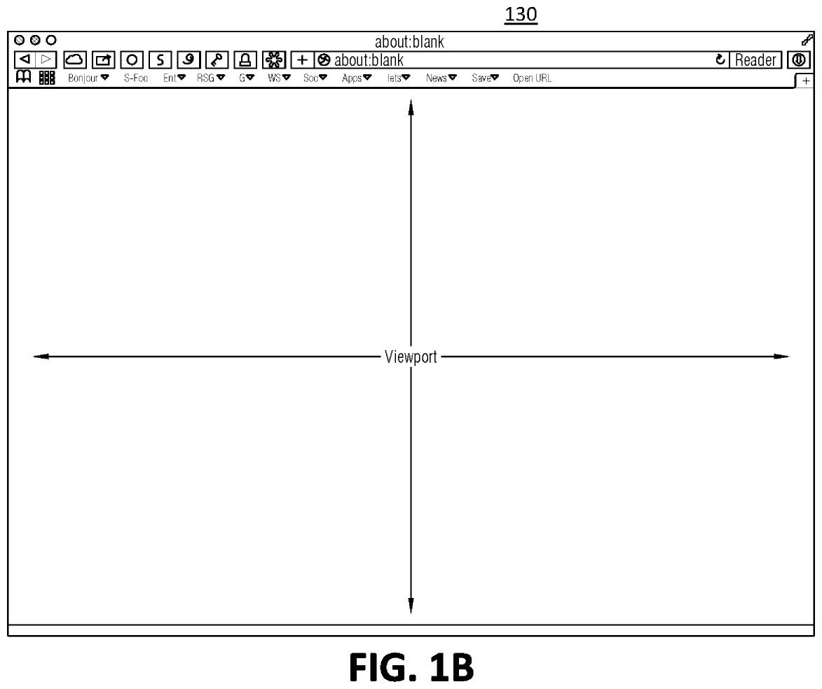

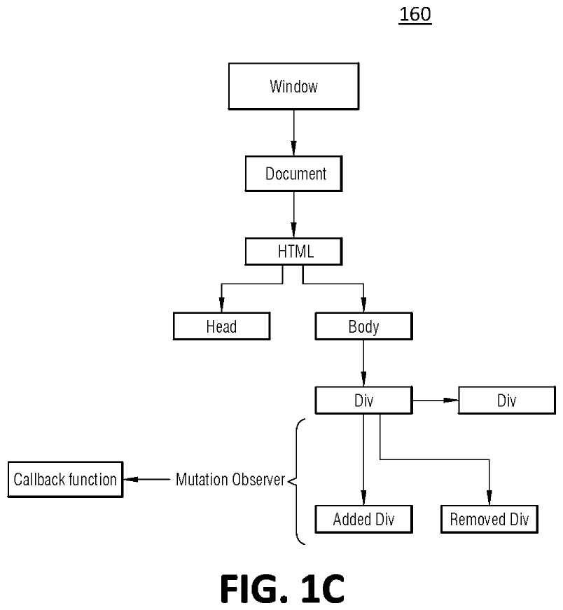

The DOM represents a document with a logical data tree. Each branch of the tree ends in a node, and each node contains objects. A node represents an HTML element. Nodes can also have event handlers attached to them. Once an event is triggered, the event handlers get executed. Turning now to FIG. 1A, is a diagram 100 of a DOM data tree is shown in accordance with one embodiment. The document is depicted as an HTML file that is further broken down into document head and a document body. The document head contains a meta element and a title element while the document body contains data elements.

All of the properties, methods, and events available for manipulating and creating web pages are organized into objects. DOM methods allow programmatic access to the tree. With them, changes may be made to the document's structure, style, or content. The DOM is built using multiple application program interfaces (APIs) that work together. The core DOM defines the entities describing any document and the objects within it. This is expanded upon as needed by other APIs that add new features and capabilities to the DOM.

A “browser” is application software for accessing websites. The browser makes requests of web servers throughout the internet on behalf of the browser user. When a user requests a web page from a particular website, the browser retrieves its files from a web server and then displays the page on the user's screen. Browsers are used on a range of devices, including desktops, laptops, tablets, and smartphones.

The purpose of a web browser is to fetch content from the internet or from local storage and display it on a user's device. This process begins when the user inputs a Uniform Resource Locator (URL), into the browser. Virtually all URLs are retrieved using the Hypertext Transfer Protocol (HTTP) which is a set of rules for the transfer of data. If the URL uses the secure mode of HTTP (HTTPS), the connection between the browser and the web server is encrypted for the purposes of communications security and information privacy.

Web pages usually contain hyperlinks to other pages and resources. Each link contains a URL, and when it is clicked or tapped, the browser navigates to the new resource. Most browsers use an internal cache of web page resources to improve loading times for subsequent visits to the same page. The cache can store many items, such as large images, so they do not need to be downloaded from the server again. Cached items are usually only stored for as long as the web server stipulates in its HTTP response messages.

A “viewport” represents the area in computer graphics being currently viewed. In web browser terms, it is generally the same as the browser window, excluding the user interface (UI), menu bar, etc. That is the section of the document a user is viewing. Turning now to FIG. 1B, a display 130 of a browser viewport is shown in accordance with one embodiment. Documents may be very long and the viewport is simply everything in the document that is currently visible. The size of the viewport depends on the size of the screen, whether the browser is in fullscreen mode or not, and whether or not the user zoomed in. Content outside the viewport is likely to not be visible onscreen until scrolled into view.

Consequently, the height and width of the viewport is not always the height width of the window. The “viewport width” is the inner width of a document in CSS pixels, including padding (but not borders, margins, or vertical scrollbars, if present). Similarly, the “viewport height” is the inner height of a document in CSS pixels, including padding (but not borders, margins, or vertical scrollbars, if present). The width and height of the viewport is often incorrectly referenced as being relative to the width and height of the browser window. Instead, it is actually relative to the viewport, which is the window in the main document but is the intrinsic size of the element's parent in a nested browsing context like objects. Therefore, these values will change every time the browser is resized.

The webpage contains two viewports, the viewport layout and the visual viewport. The area within the offset height and offset width is generally considered the “viewport layout”. The “viewport visual” is the part of the web page that is currently visible in the browser and can change. When the user pinch-zooms the page, pops open a dynamic keyboard, or when a previously hidden address bar becomes visible, the viewport visual shrinks but the viewport layout is unchanged. The viewport layout and viewport visual are not the only viewports, any sub-viewport that is fully or partially displayed within the viewport layout is also considered a viewport visual.

A “mutation observer” is an interface which provides the ability to watch for changes being made to a DOM tree. In operation, the mutation observer is a built-in object that observes DOM Changes and calls or fires a callback function to react to the changes in the DOM Tree. Turning now to FIG. 1C, a diagram 160 of a mutation observer is shown for a DOM data tree in accordance with one embodiment.

In order to interact with a browser driver to perform actions with a specific DOM element, there is a need to determine if such element is in a stable state to receive actions. With the DOM and element still mutating in browser, an action sent to an element would typically lose its original target which would cause an error exception. This results false failures for user's execution of a scripted program.

Some embodiments include an algorithm with Javascript to be injected to the browser. The algorithm does the following three tasks: check the browser's network activities to determine there are no more network activities coming to change the DOM data in a given time span; check if the interacted element a) is being scrolled to the center of the current viewport, b) has an offset-width and offset-height in the current viewport, and c) is clickable by checking if there are any overlay on top of the element's viewport location; and to check if mutation (e.g., of childlist, characterData subtree, etc.) has stopped in the current DOM using a mutation observer interface.

By combining these three results, the system determines if an element in DOM is in a stable state and not mutating. Users are then able to execute their automated script without false failure caused by performing the action to a mutating DOM element. In some embodiments, the three different watcher algorithms can use different time period frequencies for their respective status checks. These time periods may be automatically or manually determined. Additionally, although the three checks are described in the order of 1.) if network events have stopped for a period of time, 2.) if element is shown and has not been blocked in current viewport, and 3.) there is no DOM mutation been observed for a period of time, it should be understood that the checks may be performed in any order or combination as well as performed simultaneously.

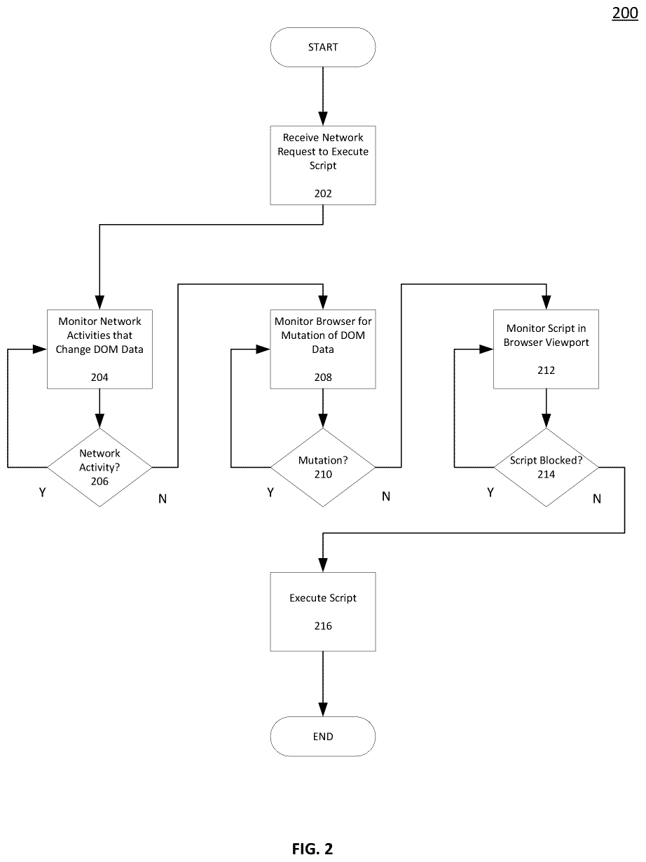

Turning now to FIG. 2, a flowchart 200 is shown for a method for monitoring and controlling the actions of a web browser in accordance with one embodiment. First, a network request for an action to execute a script is received by a browser 202. Network activities of the browser are monitored to ensure no network activities are present that change the DOM data 204. The browser is also monitored to ensure no mutation of the DOM data is taking place 208. Finally, the script is monitored to ensure that it is not blocked in a viewport of the browser 212. The script is executed 216 when it is determined that, no network activities of the browser are present 206, no mutation of the DOM data is taking place in the browser 210, and the script is not blocked in the viewport of the browser 214. While this flowchart 200 represents these three conditions being monitored in sequence, it should be understood that the order of the sequence could be changed or that the monitoring of the conditions could be done simultaneously in other embodiments.

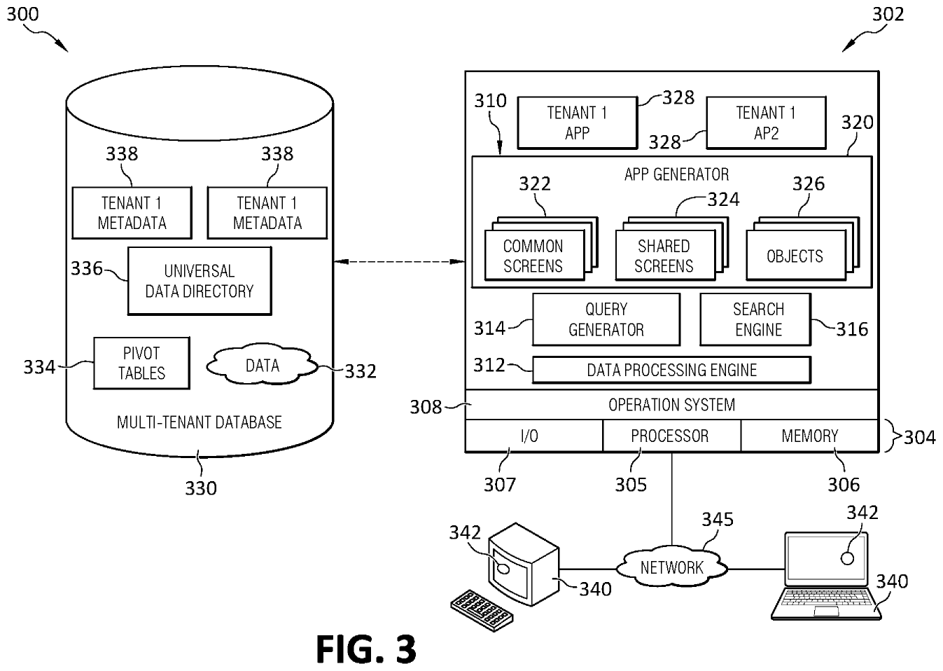

Turning now to FIG. 3, an exemplary multi-tenant system 300 includes a server 302 that dynamically creates and supports virtual applications 328 based upon data 332 from a database 330 that may be shared between multiple tenants, referred to herein as a multi-tenant database. Data and services generated by the virtual applications 328 are provided via a network 345 to any number of client devices 340, as desired. Each virtual application 328 is suitably generated at run-time (or on-demand) using a common application platform 310 that securely provides access to the data 332 in the database 330 for each of the various tenants subscribing to the multi-tenant system 300. In accordance with one non-limiting example, the multi-tenant system 300 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 330. In this regard, each tenant includes one or more users associated with, assigned to, or otherwise belonging to that respective tenant. Stated another way, each respective user within the multi-tenant system 300 is associated with, assigned to, or otherwise belongs to a particular one of the plurality of tenants supported by the multi-tenant system 300. Tenants may represent companies, corporate departments, business or legal organizations, and/or any other entities that maintain data for particular sets of users (such as their respective customers) within the multi-tenant system 300. Although multiple tenants may share access to the server 302 and the database 330, the particular data and services provided from the server 302 to each tenant can be securely isolated from those provided to other tenants. The multi-tenant architecture therefore allows different sets of users to share functionality and hardware resources without necessarily sharing any of the data 332 belonging to or otherwise associated with other tenants.

The multi-tenant database 330 may be a repository or other data storage system capable of storing and managing the data 332 associated with any number of tenants. The database 330 may be implemented using conventional database server hardware. In various embodiments, the database 330 shares processing hardware 304 with the server 302. In other embodiments, the database 330 is implemented using separate physical and/or virtual database server hardware that communicates with the server 302 to perform the various functions described herein. In an exemplary embodiment, the database 330 includes a database management system or other equivalent software capable of determining an optimal query plan for retrieving and providing a particular subset of the data 332 to an instance of virtual application 328 in response to a query initiated or otherwise provided by a virtual application 328, as described in greater detail below. The multi-tenant database 330 may alternatively be referred to herein as an on-demand database, in that the multi-tenant database 330 provides (or is available to provide) data at run-time to on-demand virtual applications 328 generated by the application platform 310, as described in greater detail below.

In practice, the data 332 may be organized and formatted in any manner to support the application platform 310. In various embodiments, the data 332 is suitably organized into a relatively small number of large data tables to maintain a semi-amorphous “heap”-type format. The data 332 can then be organized as needed for a particular virtual application 328. In various embodiments, conventional data relationships are established using any number of pivot tables 334 that establish indexing, uniqueness, relationships between entities, and/or other aspects of conventional database organization as desired. Further data manipulation and report formatting is generally performed at run-time using a variety of metadata constructs. Metadata within a universal data directory (UDD) 336, for example, can be used to describe any number of forms, reports, workflows, user access privileges, business logic and other constructs that are common to multiple tenants. Tenant-specific formatting, functions and other constructs may be maintained as tenant-specific metadata 338 for each tenant, as desired. Rather than forcing the data 332 into an inflexible global structure that is common to all tenants and applications, the database 330 is organized to be relatively amorphous, with the pivot tables 334 and the metadata 338 providing additional structure on an as-needed basis. To that end, the application platform 310 suitably uses the pivot tables 334 and/or the metadata 338 to generate “virtual” components of the virtual applications 328 to logically obtain, process, and present the relatively amorphous data 332 from the database 330.

The server 302 may be implemented using one or more actual and/or virtual computing systems that collectively provide the dynamic application platform 310 for generating the virtual applications 328. For example, the server 302 may be implemented using a cluster of actual and/or virtual servers operating in conjunction with each other, typically in association with conventional network communications, cluster management, load balancing and other features as appropriate. The server 302 operates with any sort of conventional processing hardware 304, such as a processor 305, memory 306, input/output features 307 and the like. The input/output features 307 generally represent the interface(s) to networks (e.g., to the network 345, or any other local area, wide area or other network), mass storage, display devices, data entry devices and/or the like. The processor 305 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 306 represents any non-transitory short or long term storage or other computer-readable media capable of storing programming instructions for execution on the processor 305, including any sort of random access memory (RAM), read only memory (ROM), flash memory, magnetic or optical mass storage, and/or the like. The computer-executable programming instructions, when read and executed by the server 302 and/or processor 305, cause the server 302 and/or processor 305 to create, generate, or otherwise facilitate the application platform 310 and/or virtual applications 328 and perform one or more additional tasks, operations, functions, and/or processes described herein. It should be noted that the memory 306 represents one suitable implementation of such computer-readable media, and alternatively or additionally, the server 302 could receive and cooperate with external computer-readable media that is realized as a portable or mobile component or platform, e.g., a portable hard drive, a USB flash drive, an optical disc, or the like.

The application platform 310 is any sort of software application or other data processing engine that generates the virtual applications 328 that provide data and/or services to the client devices 340. In a typical embodiment, the application platform 310 gains access to processing resources, communications interfaces and other features of the processing hardware 304 using any sort of conventional or proprietary operating system 308. The virtual applications 328 are typically generated at run-time in response to input received from the client devices 340. For the illustrated embodiment, the application platform 310 includes a bulk data processing engine 312, a query generator 314, a search engine 316 that provides text indexing and other search functionality, and a runtime application generator 320. Each of these features may be implemented as a separate process or other module, and many equivalent embodiments could include different and/or additional features, components or other modules as desired.

The runtime application generator 320 dynamically builds and executes the virtual applications 328 in response to specific requests received from the client devices 340. The virtual applications 328 are typically constructed in accordance with the tenant-specific metadata 338, which describes the particular tables, reports, interfaces and/or other features of the particular application 328. In various embodiments, each virtual application 328 generates dynamic web content that can be served to a browser or other client program 342 associated with its client device 340, as appropriate.

The runtime application generator 320 suitably interacts with the query generator 314 to efficiently obtain multi-tenant data 332 from the database 330 as needed in response to input queries initiated or otherwise provided by users of the client devices 340. In a typical embodiment, the query generator 314 considers the identity of the user requesting a particular function (along with the user's associated tenant), and then builds and executes queries to the database 330 using system-wide metadata 336, tenant specific metadata 338, pivot tables 334, and/or any other available resources. The query generator 314 in this example therefore maintains security of the common database 330 by ensuring that queries are consistent with access privileges granted to the user and/or tenant that initiated the request.

With continued reference to FIG. 3, the data processing engine 312 performs bulk processing operations on the data 332 such as uploads or downloads, updates, online transaction processing, and/or the like. In many embodiments, less urgent bulk processing of the data 332 can be scheduled to occur as processing resources become available, thereby giving priority to more urgent data processing by the query generator 314, the search engine 316, the virtual applications 328, etc.

In exemplary embodiments, the application platform 310 is utilized to create and/or generate data-driven virtual applications 328 for the tenants that they support. Such virtual applications 328 may make use of interface features such as custom (or tenant-specific) screens 324, standard (or universal) screens 322 or the like. Any number of custom and/or standard objects 326 may also be available for integration into tenant-developed virtual applications 328. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 332 associated with each virtual application 328 is provided to the database 330, as appropriate, and stored until it is requested or is otherwise needed, along with the metadata 338 that describes the particular features (e.g., reports, tables, functions, objects, fields, formulas, code, etc.) of that particular virtual application 328. For example, a virtual application 328 may include a number of objects 326 accessible to a tenant, wherein for each object 326 accessible to the tenant, information pertaining to its object type along with values for various fields associated with that respective object type are maintained as metadata 338 in the database 330. In this regard, the object type defines the structure (e.g., the formatting, functions and other constructs) of each respective object 326 and the various fields associated therewith.

Still referring to FIG. 3, the data and services provided by the server 302 can be retrieved using any sort of personal computer, mobile telephone, tablet or other network-enabled client device 340 on the network 345. In an exemplary embodiment, the client device 340 includes a display device, such as a monitor, screen, or another conventional electronic display capable of graphically presenting data and/or information retrieved from the multi-tenant database 330, as described in greater detail below. Typically, the user operates a conventional browser application or other client program 342 executed by the client device 340 to contact the server 302 via the network 345 using a networking protocol, such as the hypertext transport protocol (HTTP) or the like. The user typically authenticates his or her identity to the server 302 to obtain a session identifier (“SessionID”) that identifies the user in subsequent communications with the server 302. When the identified user requests access to a virtual application 328, the runtime application generator 320 suitably creates the application at run time based upon the metadata 338, as appropriate. As noted above, the virtual application 328 may contain Java, ActiveX, or other content that can be presented using conventional client software running on the client device 340; other embodiments may simply provide dynamic web or other content that can be presented and viewed by the user, as desired. As described in greater detail below, the query generator 314 suitably obtains the requested subsets of data 332 from the database 330 as needed to populate the tables, reports or other features of the particular virtual application 328.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

“Node/Port”—As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node). As used herein, a “port” means a node that is externally accessible via, for example, a physical connector, an input or output pin, a test probe, a bonding pad, or the like.

“Connected/Coupled”—The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematics shown depict one exemplary arrangement of elements, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed in connection with the process may be performed by software, hardware, firmware, or any combination thereof. For illustrative purposes, the description of the process may refer to elements mentioned above. In practice, portions of the process may be performed by different elements of the described system, e.g., component A, component B, or component C. It should be appreciated that process may include any number of additional or alternative tasks, the tasks shown need not be performed in the illustrated order, and the process may be incorporated into a more comprehensive procedure or process having additional functionality not described in detail herein. Moreover, one or more of the tasks could be omitted from an embodiment of the process as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method for monitoring the status of a requested action for a browser, the method comprising:
receiving a network request for an action to execute a script with the browser;
monitoring network activities of the browser to ensure no network activities are present that change a document object model (DOM) data;
monitoring the browser to ensure no mutation of the DOM data is taking place;
monitoring the script to ensure that the script is not blocked in a viewport of the browser when the script is scrolled to the central area of the viewport of the browser; and
executing the script when,
no network activities of the browser are present,
no mutation of the DOM data is taking place in the browser, and
the script is not blocked in the viewport of the browser.

2. The method of claim 1, where the network request is inbound to the browser.

3. The method of claim 1, where the network request is outbound from the browser.

4. The method of claim 1, where monitoring the browser to ensure no mutation of the DOM data is taking place is performed by a mutation observer interface.

5. The method of claim 1, where no network activities of the browser are present is determined by the lack of network activity by the browser for a predetermined period of time.

6. (canceled)

7. The method of claim 1, where the script is not blocked in the viewport of the browser is determined when the script possesses an adequate offset height in the viewport of the browser.

8. The method of claim 1, where the script is not blocked in the viewport of the browser is determined when the script possesses an adequate offset width in the viewport of the browser.

9. The method of claim 1, where the script is not blocked in the viewport of the browser is determined when the script possesses an overlay on top of the location for the script.

10. The method of claim 1, where no mutation of the DOM data is taking place in the browser is determined by the lack of mutation of the DOM data the browser for a predetermined period of time.

11. A system for monitoring the status of a requested action for a browser, the system comprising:
at least one processor; and
a memory coupled to the processor, where the memory comprises at least one non-transitory computer readable storage media that includes computer program instructions which,
receives a network request for an action to execute a script with a browser,
monitors network activities of the browser to ensure no network activities are present that change a document object model (DOM) data,
monitors the browser to ensure no mutation of the DOM data is taking place,
monitors the script to ensure that the script is not blocked in a viewport of the browser when the script is scrolled to the central area of the viewport of the browser, and
executes the script when,
no network activities of the browser are present,
no mutation of the DOM data is taking place in the browser, and
the script is not blocked in the viewport of the browser.

12. The system of claim 11, where the network request is inbound to the browser.

13. The system of claim 11, where the network request is outbound from the browser.

14. The system of claim 11, where monitoring the browser to ensure no mutation of the DOM data is taking place is done with a mutation observer interface.

15. The system of claim 11, where no network activities of the browser are present is determined by the lack of network activity by the browser for a predetermined period of time.

16. (canceled)

17. The system of claim 11, where the script is not blocked in the viewport of the browser is determined when the script possesses an adequate offset height in the viewport of the browser.

18. The system of claim 11, where the script is not blocked in the viewport of the browser is determined when the script possesses an adequate offset width in the viewport of the browser.

19. The system of claim 11, where the script is not blocked in the viewport of the browser is determined when the script possesses an overlay on top of the location for the script.

20. The system of claim 11, where no mutation of the DOM data is taking place in the browser is determined by the lack of mutation of the DOM data the browser for a predetermined period of time.
